(19) United States
(12) Patent Application Publication
(10) Pub. No.: US 2016/0289030 A1
(43) Pub. Date: Oct. 6, 2016

(54) Mechanism, method and escapement wheel for controlling rotational motion

(71) Applicant: CENTRUM BADAN KOSMICZNYCH POLSKIEJ AKADEMII NAUK, Warszawa (PL)

(72) Inventors: Marta TOKARZ, Warszawa (PL); Jerzy GRYGORCZUK, Warszawa (PL); Stanislaw JARZYNKA, Warszawa (PL)

(21) Appl. No.: 14/782,662

(22) PCT Filed: Jun. 27, 2014
(86) PCT No.: PCT/IB2014/062651

§ 371 Date: Oct. 6, 2015

(30) Foreign Application Priority Data
Oct. 15, 2013 (PL) PL405646

(51) Int. Cl. B65H 16/00; B65H 16/10

(52) U.S. Cl. CPC B65H 16/005; B65H 16/106; B65H 2403/47; G04B 15/08

(57) ABSTRACT

A rotation control mechanism for controlling of unrolling of the curling strip rolled on a drum is disclosed, which includes an escapement gear wheel fixed at the drum rotation axis, an anchor, and an electromagnet. The anchor is pivotably mounted at a distance closer to the gear wheel than the distance between the first anchor arm and the second anchor arm so that the arms alternately come into contact with the gear wheel. The rotation of the gear wheel causes swinging motion of the anchor striking the gear wheel alternately with the first anchor arm and second anchor arm reducing the rotation speed. A clamp is connected to the anchor so that turning the electromagnet on enforces movement of the clamp, pressing the first arm of the anchor against the gear wheel. A return spring connected to the anchor counteracts the force exerted on the anchor by the electromagnet via the clamp, the spring tension force being less than the electromagnet force.

The present invention concerns rotational motion controlling mechanism, rotational motion controlling method and an escapement gear wheel. More particularly, the invention is related to rotational motion of a drum or a spool during unrolling from it a wound tubular strip and serves for unrolling speed control.

Tubular strips, i.e. strips which in the relaxed state are curled along its tubular axis, have numerous applications in booms, manipulators and antennas, especially in space applications. For example, a hardened strip wound curled into a tube after stretching out and winding onto a spool has small size and weight. Unrolled from the roll it curls around the axis passing through the centre of the strip. This way, after unrolling the strip from the spool a structure constituting a thin-walled tube reappears, characterised by a very good flexural strength to weight ratio. The thickness of the strip the tube is made of is strongly dependent on the planned application, planned length of the tube and targeted loads.

Small weight and the possibility of tight “packing” of a long element and also the possibility of smooth adjustment of its length decide about the exceptional usefulness of structures made of curled strips in space applications. The devices intended for operation in space face much more strict requirements than terrestrial devices. Delivery of the structure at its destination site is an additional problem, which has to be considered already at the design stage. For carrying the structures to the mission site rockets are used, the carrying capacity and cargo space of which are very limited. Due to this, maximal reduction of the device's weight and the possibility to fold into a small volume and later to deploy after reaching the target is required.

For example, a solution wherein curled strips mechanism has been used is a manipulator, combining long reach with a small weight and small size in folded state, disclosed in document U.S. Pat. No. 3,601,940. In folded state the working strip, typically made of metal, is wound on a rotated spool. Specific cross-section of the strip causes, that when not held by the spool it curls around an axis passing through the centre of the strip. This way, after unrolling the strip from the spool a structure resembling a thin-walled tube appears. Thus, there is formed an element the length thereof can be adjusted in a significant range by winding and unrolling the strip from the spool. Similar solutions have been disclosed in other documents, like e.g. in U.S. Pat. No. 3,434,674. In this document preferable ranges of thickness of the strips have been indicated and the most typical materials for their construction have been listed. Among them are: carbon steel, stainless steel, beryllium bronze, titanium alloys and fibre composites (e.g. glass or carbon fibres) like e.g. carbon fibre reinforced polymer (CFRP).

Reliable unwinding of strips in structures of booms, antennas and a manipulator is very important in space applications, because the possibilities of repairing the structure or manual deployment after launching from Earth are limited or do not exist at all.

In the report NASA SPACE VEHICLE DESIGN CRITERIA GUIDANCE AND CONTROL entitled “Tubular spacecraft booms (extendible reel stored)”, dated February 1971, there are disclosed typical failures of structures employing curled strips and their causes. Included have been, inter alia, failure of motor driving the spool where the strip has been wound, failure of power supply and jamming of the strip on the spool.

In the strip wound on the spool the is stored energy. In the case of strips made of carbon steel and beryllium bronze the energy allows to self-unroll of the strip. It is very advantageous, since it allows to eliminate the motor, damage of which is one of the most frequent causes of failure, or at least to reduce its function to wind the strip back onto the roll when it is required to adjust its length.

In terrestrial conditions such strip unrolls very abruptly and quickly, reliably. In application at very small satellites or spacecrafts such abrupt deployment of structural element can lead to the loss of stability. On the other hand, in space conditions, frequently after a long flight, elastic properties can be partially lost and a mechanism facilitating the deployment can become necessary. It is an object of the present invention to provide a mechanism controlling the unrolling of the strip with both functions: supporting drawing the strip out of the roll and also restraining the speed of drawing the strip out of the roll.

In the state of the art, for example from the handbook Z. Mrugalski, “Mechanizmy zegarowe”, Wydawnictwa Naukowo Techniczne, Warszawa 1972, there are known various escapement mechanisms enabling temporal locking of a spring driven wheel. In these mechanism an anchor “catching” the escapement wheel has been applied. The anchor has caught the wheel locking it. For this purpose the teeth of the escapement wheel have been inclined at an angle such that the straight line between the tooth's tip and the escapement wheel's axle was not located fully in the escapement wheel and partially passed the space between the teeth. Because of this the end of the anchor's arm introduced between the teeth locks itself the stronger the harder the spring pushes the escapement wheel. In clocks it is released by means of pendulum. Thereby a movement of hands timed by the pendulum is obtained. An attempt to apply such escapement for curled tubular strips would require to expand the mechanism with and additional timing system, possibly being an additional source of failure. Further in the case of partial loss of elasticity by the strip and no possibility of its unassisted unrolling, the mechanism would be useless.

The aim of the invention is to solve the problems highlighted above and to provide such mechanism and method for controlling rotation of an element, which make it possible to control the unrolling of curled tubular strips. Furthermore, the aim of the invention is to provide an escapement wheel, which enables not only restraining of the rotational motion, but also its stimulation.

An element rotation control mechanism according to the invention is suitable for controlling of unrolling of the curling strip rolled on a drum, the mechanism comprising an escapement gear wheel (2) fixed at the axis of rotation of the drum and an anchor. Anchor is pivotably mounted at a distance less than half of the span between the first anchor arm and the second anchor arm from the escapement gear wheel so that the first anchor arm and the second anchor arm can come into contact with the escapement gear wheel in alternate manner. Wherein the teeth of the escapement gear wheel have edges shaped so that anchor arm slides on them without locking when the anchor arm and escapement wheel are in contact, so that the rotation of the escapement gear wheel causes swinging motion of the anchor striking the gear wheel alternately with the first anchor arm and second anchor arm reducing therefore the speed of rotation. The radius of the escapement wheel as well as the dimensions and the number of teeth are chosen such that in the position of the escapement wheel, where one of the arms of the anchor has its point of contact with the escapement wheel located exactly at the bottom of the inter-tooth notch, the point of contact of the second arm of the anchor is located at the rear edge of a tooth. The mechanism further comprises an electromagnet and a clamp mounted moveably with respect to it, wherein the clamp is connected to the anchor so that turning the electromagnet on enforces movement of the clamp, that presses the first arm of the anchor against the escapement gear wheel, and a return spring connected with the anchor, mounted so that it counteracts the force exerted on the anchor by the electromagnet via the clamp, wherein the tension force of the spring is less than the force of the electromagnet.

Preferably the teeth of the escapement wheel have substantially the shape of an acute-angled triangle with sides of different length, and n+½ teeth are accommodated on the arc segment of the escapement wheel bounded by the point of contact of the first arm of the anchor with the escapement wheel and the point of contact of the second arm of the anchor with the escapement wheel, where n is a natural number.

Preferably the frontal edges of teeth are inclined at an angle within the range of 20° to 30° with respect to the straight line connecting the tip of the tooth with the centre of the escapement wheel, and rear edges of teeth are inclined at an angle within the range of 50° to 60° with respect to the straight line connecting the tip of the tooth the centre of the escapement wheel.

Preferably the escapement gear wheel has 25 to 35 teeth.

An element rotation control method according to the invention is used with a mechanism for controlling of unrolling of the curling strip rolled on a drum having an escapement gear wheel fixed at the axis of rotation of the drum. The mechanism further has an anchor pivotably mounted at a distance less than half of the span between the first anchor arm and the second anchor arm from the escapement gear wheel so that the first anchor arm and the second anchor arm can come into contact with the escapement gear wheel in alternate manner. The teeth of the escapement gear wheel have edges shaped so that anchor arm slides on them without locking when the anchor arm and escapement wheel are in contact. The radius of the escapement wheel as well as the dimensions and the number of teeth are chosen such that in the position of the escapement wheel, where one of the arms of the anchor has its point of contact with the escapement wheel located exactly at the bottom of the inter-tooth notch, the point of contact of the second arm of the anchor is located at the rear edge of a tooth. The mechanism further comprises an electromagnet and a clamp mounted moveably with respect to it, wherein the clamp is connected to the anchor so that turning the electromagnet on enforces movement of the clamp, which moving presses an arm of the anchor against the escapement gear wheel and a return spring connected with the anchor, mounted so that it counteracts the force exerted on the anchor by the electromagnet via the clamp, wherein the tension force of the spring is less than the force of the electromagnet. The method comprises a step of periodically turning on the electromagnet to accelerate unrolling of the curling strip when it stops unrolling itself.

Preferably the teeth of the escapement wheel are chosen such that they have substantially the shape of an acute-angled triangle with sides of different length, and n+½ teeth are accommodated on the arc segment of the escapement wheel bounded by the point of contact of the first arm of the anchor with the escapement wheel and the point of contact of the second arm of the anchor with the escapement wheel, where n is a natural number.

Preferably the teeth of the escapement wheel are chosen so that the frontal edges of the teeth are inclined at an angle within the range of 20° to 30° with respect to the straight line connecting the tip of the tooth with the centre of the escapement wheel, and the rear edges of the teeth are inclined at an angle within the range of 50° to 60° with respect to the straight line connecting the tip of the tooth with the centre of the escapement wheel.

Preferably the escapement gear wheel is chosen such that is has 25 to 35 teeth.

The invention has been explained in embodiments presented with reference to the drawings, wherein

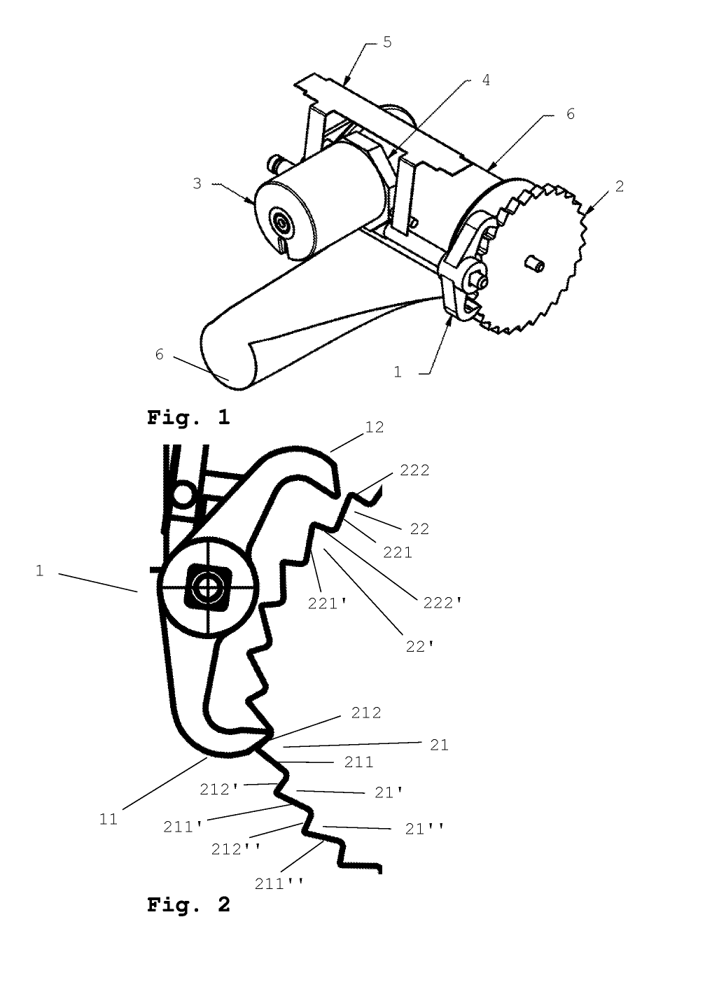

FIG. 1 shows a strip wound on a spool with the mechanism according to the invention,

FIG. 2 shows a portion of the escapement wheel of the mechanism according to the invention with shown teeth and an anchor,

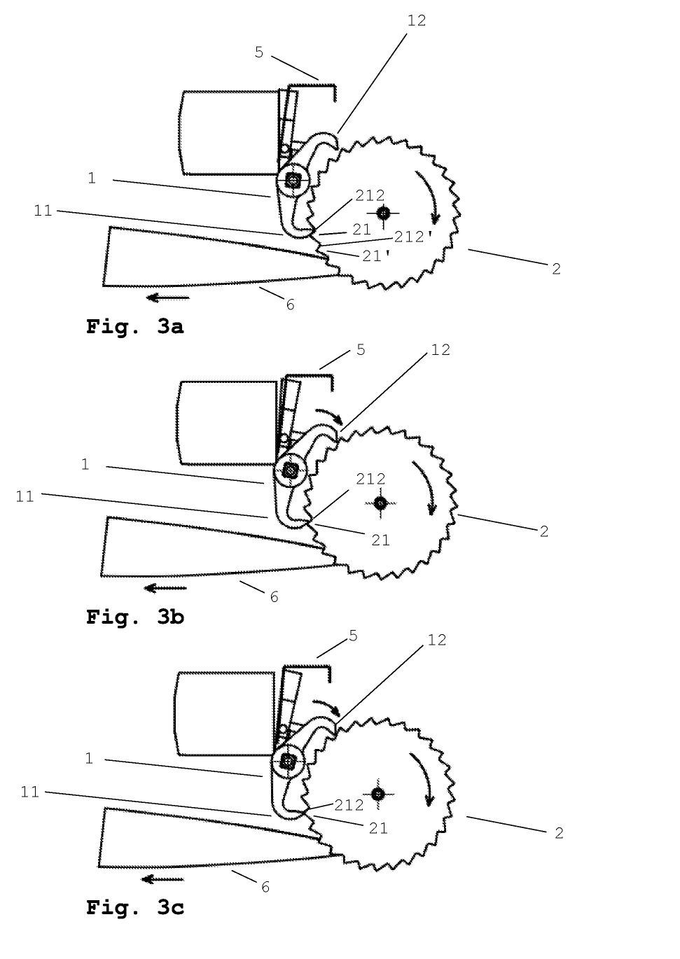

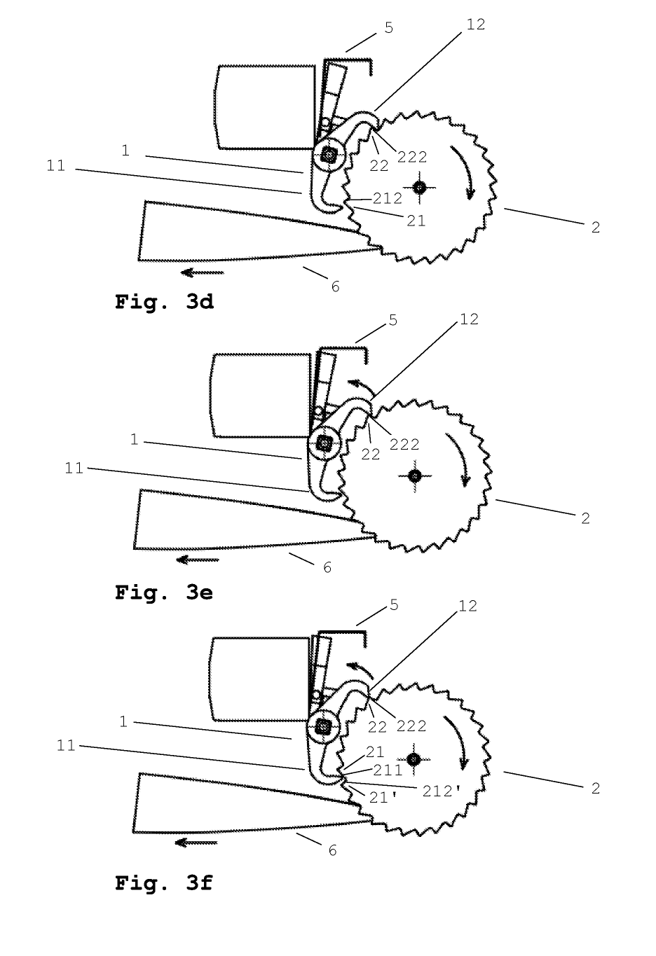

FIG. 3a shows a side view of the mechanism according to the invention in its initial position,

FIG. 3b shows a side view of the mechanism according to the invention during unrolling of the strip in the first phase of the unassisted unrolling,

FIG. 3c shows a side view of the mechanism according to the invention during unrolling of the strip during the second phase of the cycle of unassisted unrolling,

FIG. 3d shows a side view of the mechanism according to the invention during unrolling of the strip in the third phase of the cycle of the unassisted unrolling,

FIG. 3e shows a side view of the mechanism according to the invention during unrolling of the strip in the fourth phase of the cycle of unassisted unrolling,

FIG. 3f shows a side view of the mechanism according to the invention during unrolling of the strip in the fifth phase of the cycle of unassisted unrolling,

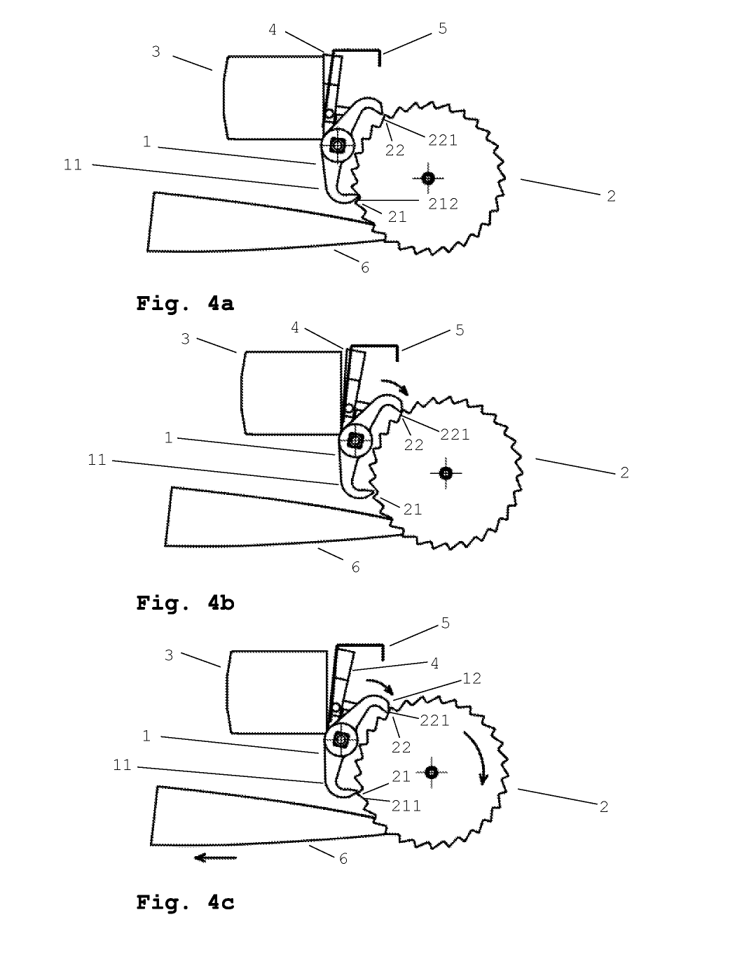

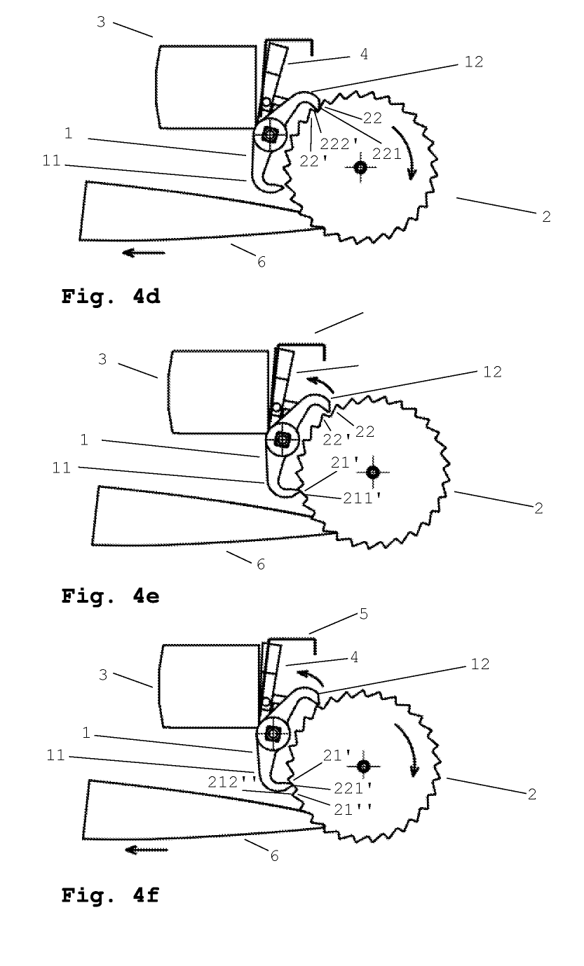

FIG. 4a shows a side view of the mechanism according to the invention in the initial position,

FIG. 4b shows a side view of the mechanism according to the invention during unrolling of the strip in the first phase of the cycle of assisted unrolling,

FIG. 4c shows a side view of the mechanism according to the invention during unrolling of the strip in the second phase of the cycle of assisted unrolling,

FIG. 4d shows a side view of the mechanism according to the invention during unrolling of the strip in the third phase of the cycle of assisted unrolling,

FIG. 4e shows a side view of the mechanism according to the invention during unrolling of the strip in the fourth phase of the cycle of assisted unrolling,

FIG. 4f shows a side view of the mechanism according to the invention during unrolling the strip in the fifth phase of the cycle of assisted unrolling,

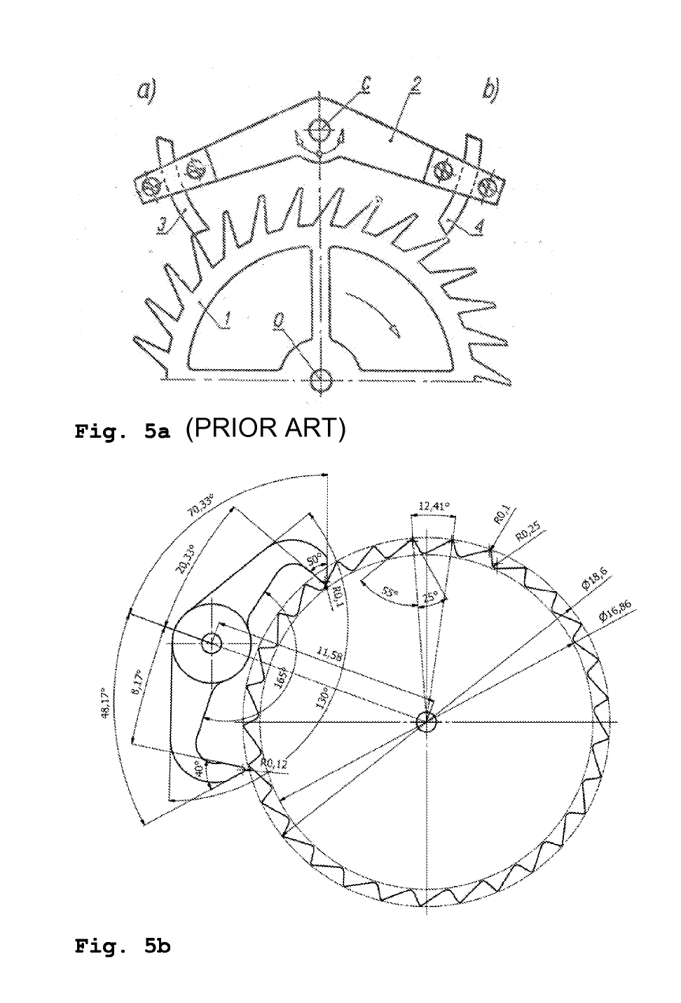

FIG. 5a shows the known in the art Graham escapement with an anchor and an escapement wheel, and

FIG. 5b shows the anchor and the escapement wheel according to the invention.

The mechanism controlling the unrolling of the elastic strip from the spool has been shown in perspective in FIG. 1. The strip 6 in wound on a spool, not shown in the figure. The control of rotation of this spool in fact makes it possible to control the unrolling of the strip 6. An escapement wheel 2 is attached to the spool on a common axis. Near the escapement wheel 2 on an axle with bearing, connected with the clamp 4 of the electromagnet there is arranged an anchor 1. In the case when the clamp 4 is attracted to the electromagnet, the arm 11 of the anchor 1 shown in side view in FIG. 2 is pressed against the escapement wheel 2. The clamp 4 is drawn away from the electromagnet by the return spring 5. In the situation when the clamp 4 is drawn away from the electromagnet 3 the arm 12 of the anchor 1 shown in side view in FIG. 2 is pressed against the escapement wheel.

In FIG. 2 there is shown in side view a portion of the escapement wheel 2 and the anchor 1. The shape of the teeth of the escapement wheel 2 is chosen such that the wheel rotating without assistance moved and rotated the anchor 1 alternately, so that the first arm 11 and the second arm 12 alternately cooperate with the teeth of the rotating wheel. In typical mechanisms the oscillatory movement of the anchor is enforced by means of external means and the teeth of the escapement wheel have such a shape to jam on the escapement wheel teeth, as shown in FIG. 5a. In the solution according to the invention the shape of the teeth has been chosen such that the straight line between the top of a tooth and the centre of the escapement wheel is fully enclosed within the escapement wheel. Because of this it can be ensured that the anchor will not be jammed. In addition, the application of the teeth with a shape resembling acute-angled triangle with uneven sides makes it possible to use the anchor 1 for two purposes. The anchor can limit self-unrolling of the strip and simultaneously it can be used for driving the escapement wheel if the strip does not unroll by itself. In the case of unassisted unrolling of the strip with the wheel rotating clockwise the arms of the anchor alternately strike the teeth of the escapement wheel restraining its motion. The restraining force depends on the shape of the teeth and the anchor's arms as well as on its weight. More precisely, the tooth 21 with its frontal edge 212 raises the first arm of the anchor, then the second arm of the anchor 12 falls on the rear edge 221 of the tooth 22, afterwards the frontal edge 222′ of the next tooth 22′ raises the arm 12 of the anchor and the arm 11 falls on the rear edge 211 of the tooth 21 to be subsequently risen by the frontal edge 212′ of the next tooth 21′. This way the inertia of the anchor 1 serves for restraining of the speed of movement of the escapement wheel's teeth, and in consequence for restraining the rotational speed.

In the case of assisted motion, the stimulated oscillatory moves of the anchor 1 and its arms' ends into the teeth of the escapement wheel enforce the rotational motion of the escapement wheel in the case when the elastic energy stored in the strip is insufficient for self-unrolling. For stimulation of the anchor's movement a number of available technical means can be used, for example, the arrangement of an electromagnet and a spring, not shown in FIG. 2 but described in details in reference to FIG. 4. In the case shown in FIG. 2 the electromagnet is turned on. Turning the electromagnet off will cause the return spring to press the arm 12 of the anchor against the rear edge 221 of the tooth 22, the arm sliding over the tooth towards the bottom of the inter-tooth notch, thus in this case the contact of the edge 221 of the tooth 22 and the edge 222′ of the tooth 22′ will enforce the movement of the escapement wheel. Subsequent turning the electromagnet on in this case causes subsequent pressing of the arm 11 of the anchor 1 against the escapement wheel. However, the point of contact will be already located at the rear edge 211 of the tooth 21. The arm sliding over this edge will subsequently enforce the movement of the wheel until it leans against the edge 212′ at the bottom of the inter-tooth notch, i.e. a the contact of the edges 211 of the tooth 21 and 212′ of the tooth 21′. This process has been presented in details with reference to FIG. 4 in a further part of the description.

The span of the arms of the anchor 1, the shape and the number of teeth and the radius of the escapement wheel 2 are carefully chosen. Let us consider an arc of the escapement wheel limited at one end by the point, where the first arm 11 of the anchor 1 contacts the wheel, and at the other end by the point, where the second arm 12 of the anchor 1 contacts the wheel. On this arc there is located a non-integer number of teeth. Therefore, if one of the anchor's arms contacts the wheel exactly at the tip of a tooth or in a point located exactly between two teeth, i.e. in such places, where an arm striking cannot enforce movement of the wheel, then after rotation of the anchor the second arm will always hit a tooth's edge. Such arrangement causes, that the wheel's teeth striking alternately the arms 11 and 12 of the anchor enforce its swinging motion.

Furthermore, such configuration helps to avoid the situation, when none of the anchor's arms can enforce the movement of the wheel 2 in the case of stimulation of oscillatory movement of the anchor by means of the electromagnet 3 and the spring 5.

The use of asymmetric triangular teeth makes it possible to enforce by the anchor the movement in a defined direction. If the teeth are asymmetric and between the points defined on the wheel 2 by the arms of the anchor 1 there are accommodated ca. n+½ teeth, where n is a natural number, then in the movement stimulated by alternating rotation of the anchor, the ends of the anchor will always fall on the rear edges of teeth. A half of a tooth is defined by the line being the bisector of the angle defined by the centre of the escapement wheel and two adjacent inter-tooth notches.

Those skilled in the art of clockworks are capable of choosing without problems the pressing force of the electromagnet 3 and the spring 5, the shape and the number of the teeth of the escapement wheel 2 and the shape of the ends of the arms 11 and 12 of the anchor 1 and their span so that the anchor 1 being pressed against the escapement wheel 2 by the electromagnet 3 or the spring 5 jammed or not. Detailed information on this subject can be found in the handbook Z. Mrugalski, “Mechanizmy zegarowe”, Wydawnictwa Naukowo Techniczne, Warszawa 1972. This reference fully complements the disclosure of the invention. Alternative shapes of the teeth, for example with convex, rounded edges can be used to reduce the risk of the mechanism jamming.

Unassisted rotation has been shown in FIGS. 3a-f. In the initial case, shown in FIG. 3a, the escapement wheel 2 being moved by the unrolled strip 6 presses the first arm 11 of the anchor 1. Next, in the first phase of the cycle of unassisted unrolling the first arm 11 of the anchor 1 slides over the edge 212 of the tooth 21 of the escapement wheel 2. The anchor 1 swings aside, what is shown by the arrow in FIG. 3b. This movement is assisted by the operation of the return spring 5. In the second phase of the cycle there occurs a moment when the first arm 11 of the anchor 1 has completely sledded from the slope 212 of the tooth 21 of the escapement wheel 2. The free rotation of the wheel begins, shown in FIG. 3c. In the third phase, the slope 222 of the tooth 22 of the escapement wheel 2 leans against the second arm 12 of the anchor 1, what is shown in FIG. 3d. Next, the second arm 12 of the anchor 1 slides over the slope 222 of the tooth 22 of the escapement wheel 2 overcoming the operation of the return spring 5. This is the fourth phase, shown in FIG. 3e. In the fifth phase, the second arm 12 of the anchor 1 completely slides off from the slope 222 of the tooth 22 of the escapement wheel 2. A temporal free motion of the escapement wheel 1 begins, shown in FIG. 3f. The anchor 1, under the operation of the return spring 5, comes back to the position in which it was in the fourth phase. The first arm 11 of the anchor 1 leans against the slope 212′ of the next tooth 21′ of the wheel 2, what corresponds to the first phase of motion, shown in FIG. 3b

The assisted unrolling of the strip has been shown in FIG. 4a-f. In the drawing the are marked schematically the electromagnet 3, the return spring 5 and the clamp 4. The term clamp has been used here in context of an element, which can be attracted by the electromagnet. Typically, so called are elements capable of closing “clamp” the magnetic flux.

In the first phase, shown in FIG. 4a, the first arm 11 of the anchor 1 leans against the escapement wheel 2. The electromagnet 3 is turned on, and the clamp 4 is attracted to the electromagnet 3. Next, in the second phase of the cycle of assisted unrolling, the electromagnet 3 turns off and the return spring 5 retracts the clamp 4. The anchor 1 then strikes with its second arm 12 into the slope 221 of the tooth 22 of the escapement wheel 2. The movement of the anchor is shown by the arrow in FIG. 4b. The operation of the return spring 5 pressing the arm 12 of the anchor 1 against the slope 221 of a tooth 22 of the escapement wheel 2 enforces the rotation of the wheel. This is the third phase shown in FIG. 4c. The clockwise movement of the escapement wheel 2 is shown by an arrow. In the fourth phase, the anchor 3 reaches the end of its range of movement and its arm 12 is located exactly between the tooth 22 and 22′ of the escapement wheel 2, at the confluence of their slopes 221 and 222′. Next, in the fifth phase the electromagnet 3 turns on again, which attracts the clamp 4 rotating the anchor 1 so that it strikes with the first arm 11 into the slope 211′ of the tooth 21′ of the escapement wheel 2. In the sixth phase, further attraction of the clamp 4 by the electromagnet 3 occurs, the anchor 1 continuing its rotational motion presses with the first arm 11 against the slope 221′ of the tooth 21′ and slides over it, thereby pushing the escapement wheel. In the moment that the anchor 3 reaches the end of the range of movement, its first arm 11 is located exactly between the tooth 21′ and 21″ of the escapement wheel 2, what corresponds to the first phase of motion, shown in FIG. 4a.

The inventors have observed, that the above described operation of the escapement wheel 2 and its cooperation with the anchor 1 can be obtained when the frontal edges of escapement wheel's teeth are inclined at an angle within the range of 20° to 30° with respect to the straight line connecting the tip of a tooth with the centre of the escapement wheel 2, and the rear edges of the escapement wheel's teeth are inclined at an angle within the range of 50° to 60° with respect to the straight line connecting the tip of a tooth with the centre of the escapement wheel 2. For this range of values it is easy to obtain the effect of not jamming the anchor.

A particularly preferable embodiment of the escapement wheel has been shown in details in FIG. 5b. In this embodiment, the rear edges of teeth are inclined at the angle of 55°, and the frontal ones at the angle of 25°. The radius of a tooth's tip curvature is 0.1 mm, and the radius if the inter-tooth notch's bottom curvature is 0.25 mm. The diameter of the escapement wheel is 18.6 mm, and on its circumference there are 29 teeth. Thus, to each tooth corresponds the angular spread on the wheel equal to 12.41°. The bottom of the inter-tooth notch is located at the distance of 16.86 mm from the centre of the escapement wheel. The anchor is suspended at the distance of 11.58 mm from the centre of the escapement wheel. The first arm of the anchor ends with a tapered end with the spread angle of 40° and the tip with the curvature radius of 0.12 mm. The second arm of the anchor ends with a tapered end with the spread angle of 50° and the tip with the curvature radius of 0.1 mm. Between them there are five complete teeth and a half of the next one. The force of the electromagnet used in the mechanism with the above described wheel is ca. 0.6 N and the force of the return spring is ca. 0.4 N.

Escapement gear wheels with a large number of teeth are difficult to produce. However, with a too low number of teeth the movement of the strip is not smooth. Furthermore, with a low number of teeth the teeth have to be bigger, thus in turn enforcing a large range of movement of the anchor. The large range of movement of the anchor means that the clamp 4 in its terminal position is further from the electromagnet 3. This in turn makes it necessary to use a bigger and stronger electromagnet and increase the dimensions of the device. It follows from experiments that the optimal number of teeth is between 25 and 35.

An additional advantage of using the mechanism according to the invention for control of unrolling speed of tubular strips is that in the case of jamming the strip it is possible to use the electromagnet with high frequency excitation to generate a series of shaking moves, which allow to gradually rotate the drum and unlock the jammed strip.

1. An element rotation control mechanism for controlling of unrolling of the curling strip (6) rolled on a drum, the mechanism comprising an escapement gear wheel (2) fixed at the axis of rotation of the drum and an anchor (1) pivotably mounted at a distance less than half of the s pan between the first anchor arm (11) and the second anchor arm (12) from the escapement gear wheel (2) so that the first anchor arm (11) and the second anchor arm (12) can come into contact with the escapement gear wheel (2) in alternate manner,
wherein the teeth (21, 21′, 22, 22′) of the escapement gear wheel (2) have edges (211, 211′, 221, 221′) shaped so that anchor arm (11, 12) slides on them without locking when the anchor arm (11, 12) and escapement wheel (2) are in contact, so that the rotation of the escapement gear wheel (2) causes swinging motion of the anchor (1) striking the gear wheel (2) alternately with the first anchor arm (11) and second anchor arm (12) reducing therefore the speed of rotation,
and the radius of the escapement wheel (2) as well as the dimensions and the number of teeth (21, 21′, 22, 22′) are chosen such that in the position of the escapement wheel (2), where one of the arms of the anchor (1) has its point of contact with the escapement wheel (2) located exactly at the bottom of the inter-tooth notch, the point of contact of the second arm of the anchor is located at the rear edge of a tooth (211, 211′, 221, 221′),
the mechanism further comprising
an electromagnet (3) and a clamp (4) mounted moveably with respect to the electromagnet, wherein the clamp (4) is connected to the anchor (1) so that turning the electromagnet (3) on enforces movement of the clamp (4), that presses the first arm (11) of the anchor (1) against the escapement gear wheel (2), and
a return spring (5) connected with the anchor (1), mounted so that the spring counteracts the force exerted on the anchor by the electromagnet (3) via the clamp (4), wherein the tension force of the spring is less than the force of the electromagnet.

2. The control mechanism according to claim 1, wherein the teeth of the escapement wheel have substantially the shape of an acute-angled triangle with sides of different length, and on the arc segment of the escapement wheel (2) bounded by the point of contact of the first arm (11) of the anchor (1) with the escapement wheel (2) and the point of contact of the second arm (12) of the anchor (1) with the escapement wheel (2) there are accommodated n+½ teeth, where n is a natural number.

3. The control mechanism according to claim 2, wherein the frontal edges of teeth (12, 12′,22, 22′) are inclined at an angle with in the range of 20° to 30° with respect to the straight line connecting the tip of a tooth with the centre of the escapement wheel (2), and the rear edges of teeth (11, 11′, 21, 21′) are inclined at an angle within the range of 50° to 60° with respect to the straight line connecting the tip of a tooth with the centre of the escapement wheel (2).

4. The control mechanism according to claim 1, wherein the escapement gear wheel (2) comprises 25 to 35 teeth.

5. An element rotation control method, with a mechanism for controlling of unrolling of the curling strip (6) rolled on a drum having an escapement gear wheel (2) fixed at the axis of rotation of the drum, the mechanism further having an anchor (1) pivotably mounted at a distance less than half of the span between the first anchor arm (11) and the second anchor arm (12) from the escapement gear wheel so that the first anchor arm (11) and the second anchor arm (12) can come into contact with the escapement gear wheel (2) in alternate manner,
wherein the teeth (21, 21′, 22, 22′) have edges (211, 211′, 221, 221′) shaped so that anchor arm (11, 12) slides on them without locking when the anchor arm (11, 12) and escapement wheel (2) are in contact,
and the radius of the escapement wheel (2) as well as the dimensions and the number of teeth (21, 21′, 22, 22′) are chosen such that in the position of the escapement wheel (2), where one of the arms of the anchor (1) has a point of contact with the escapement wheel (2) located exactly at the bottom of the inter-tooth notch, the point of contact of the second arm of the anchor is located at the rear edge of a tooth (211, 211′, 221, 221′),
the mechanism further comprising
an electromagnet (3) and a clamp (4) mounted moveably with respect to the electromagnet, wherein the clamp (4) is connected to the anchor (1) so that turning the electromagnet (3) on enforces movement of the clamp (4), which moving presses an arm of the anchor (1) against the escapement gear wheel (2), and
a return spring (5) connected with the anchor (1), mounted so that the spring counteracts the force exerted on the anchor by the electromagnet (3) via the clamp (4) wherein the tension force of the spring is less than the force of the electromagnet,
the method comprising a step of periodically turning on the electromagnet (3) obtain strike of the anchor (1) onto rear edge (211, 211′, 221, 221′) of tooth (21, 21′, 22, 22) and acceleration of the unrolling of the curling strip (6) when the curling strip (6) stops unrolling itself.

6. The control method according to claim 5, wherein the teeth of the escapement wheel are chosen such that they have substantially the shape of an acute-angled triangle with sides of different length, and on the arc segment of the escapement wheel (2) bounded by the point of contact of the first arm (11) of the anchor (1) with the escapement wheel (2) and the point of contact of the second arm (12) of the anchor (1) with the escapement wheel (2), there are n+½ teeth, where n is a natural number.

7. The control method according to claim 7, wherein the teeth of the escapement wheel are chosen such that the frontal edges of teeth (12, 12′, 22, 22′) are inclined at an angle within the range of 20° to 30° with respect to the straight line connecting the tip of a tooth with the centre of the escapement wheel (2), and the rear edges of teeth (11, 11′, 21, 21′) are inclined at an angle within the range of 50° to 60° with respect to the straight line connecting the tip of a tooth with the centre of the escapement wheel (2).

8. The control method according to claim 5, wherein the escapement gear wheel (2) is chosen such that the wheel comprises 25 to 35 teeth.
